(19) United States
(12) Patent Application Publication
(10) Pub. No.: US 2016/0273713 A1
(43) Pub. Date: Sep. 22, 2016

(54) FUEL GAS TANK FILLING SYSTEM AND METHOD

(71) Applicant: ALTERNATIVE FUEL CONTAINERS, LLC, Southfield, MI (US)

(72) Inventor: Joong-Kyu Lee, Chatham (CA)

(21) Appl. No.: 15/032,510

(22) PCT Filed: Oct. 28, 2014
(86) PCT No.: PCT/US2014/062607

§ 371 Date: Apr. 27, 2016

Related U.S. Application Data
(60) Provisional application No. 61/896,508, filed on Oct. 28, 2013.

(51) Int. Cl. F17C 11/00; F17C 5/06

(52) U.S. Cl. CPC F17C 11/007; F17C 5/06; F17C 2221/033; F17C 2221/012; F17C 2223/0123; F17C 2225/0176; F17C 2227/0337; F17C 2227/0372; F17C 2260/046; F17C 2265/065

(57) ABSTRACT

Disclosed is a system and method of filling a fuel gas storage tank, which houses a fuel gas storage material, with a fuel gas such as natural gas or hydrogen gas. The fuel gas storage tank includes an inlet, and outlet, and at least one filter tube disposed in the tank interior that fluidly communicates with at least one of the inlet or the outlet. The at least one filter tube defines a flow passage on its inside and is permeable to fuel gas such that fuel gas can diffuse from the flow passage inside the filter tube to outside of the filter tube. When filling the fuel gas storage tank, a flow of fuel gas is passed through the flow passage so that some of the fuel gas can diffuse out of the filter tube an into the tank interior for charging into the fuel gas storage material.

### CROSS-REFERENCE TO RELATED APPLICATIONS

This application claims the benefit of U.S. provisional patent application No. 61/896,508 filed on Oct. 28, 2013, the entire contents of which are incorporated herein by reference.

### TECHNICAL FIELD

The technical field of this disclosure relates generally to storage tanks for storing fuel gas and, more particularly, to a system and method for filling a fuel gas storage tank.

### BACKGROUND

The use of alternative fuel gasses as a fuel source for motor vehicle applications is gaining commercial traction. Natural gas, for example, is comprised primarily of methane (CH₄) and, currently, can be combustibly consumed to power dedicated natural gas vehicles, which are fueled only by natural gas, or dual-fuel vehicles that are fueled by a combination of traditional petrol-based fuels and natural gas through separate fueling systems. Natural gas may be stored in an on-board fuel storage tank in two plausible ways: as compressed natural gas (CNG) or adsorbed natural gas (ANG). Compressed natural gas is natural gas that is contained within a tank—usually a cylindrical or spherical tank—at less than 1% of the volume it would normally occupy at standard temperature and pressure (STP). Tank pressures of 150 bar to 250 bar are typically needed to achieve this level of compression.

Adsorbed natural gas is natural gas that is stored in a solid state by way of adsorbtion onto a natural gas storage material housed within a tank. The natural gas storage material increases the volumetric and gravimetric energy density of the gas within the available tank space such that it compares favorably to CNG but at a much lower pressure of 60 bar or less. Several different kinds of natural gas storage materials are known in the art including activated carbon and, more recently, metal-organic-frameworks (MOFs) and porous polymer networks (PPNs) that have an affinity for natural gas. MOFs, in general, are high surface area coordination polymers having an inorganic-organic framework, often a three-dimensional network, that includes metal ions (or clusters) bound by organic ligands. Many different types of MOFs that are able to reversibly adsorb natural gas are commercially available in the marketplace and newly-identified MOFs are constantly being researched and developed.

Another type of alternative fuel gas is hydrogen, which, like natural gas, can also be stored in a compressed state or on a hydrogen storage material. Storing hydrogen gas in a solid state on a hydrogen storage material has similar thermodynamics to storing natural gas on an ANG storage material even though hydrogen uptake may be chemical in nature as opposed to adsorptive. Hydrogen gas, for instance, can be reversibly stored as a hydride on a hydrogen storage material such as a metal hydride or a complex metal hydride. One specific example of a suitable metal hydride is lithium hydride (LH). Complex metal hydrides may include various known alanates and amides. Some specific complex metal hydrides include sodium alanate (NaAlH₄), lithium alanate (LiAlH₄), magnesium nickel hydride (Mg₂NiH₄), and lithium amide (LiNH₂). There are, of course, many other hydrogen storage materials that are commercially available.

While fuel gasses such as natural gas and hydrogen gas can be stored in a solid state at a lower pressure, compared to CNG, the time needed to fill a fuel gas storage tank that houses an appropriate fuel gas storage material can be extensive. Indeed, because the process of charging the fuel gas into the fuel gas storage material is exothermic—which in turn may limit the rate at which additional fuel gas is accrued and stored in a solid state—the time needed to charge enough fuel gas into a storage tank to provide a reasonable driving distance for a vehicle can last hours. Such long filling times may not necessarily be a problem for in-home or other overnight filling stations. They may, however, be unacceptable for filling stations that require faster filling times, such as commercial drive-up filling stations that service the public. Nonetheless, and no matter the circumstances, the ability to improve the rate at which solid state fuel gas storage can be achieved so as to reduce the time needed to fill an associated storage tank would make the use of fuel gas technologies a more attractive option for motor vehicle applications.

### SUMMARY

A system and method of for filling a fuel gas storage tank with a fuel gas, such as natural gas or hydrogen gas, is disclosed. The system includes a fuel gas storage tank that includes an inlet, an outlet, a fuel gas storage material within an interior of the storage tank, and at least one filter tube disposed within the tank interior and extending through the bulk of the fuel gas storage material. The filter tube fluidly communicates with at least one of the inlet and the outlet and defines a flow passage through which a flow of fuel gas can navigate. The filter tube, moreover, is permeable to fuel gas, meaning that fuel gas can diffuse from the flow passage inside the filter tube into the tank interior outside of the filter tube. Heat that is generated from the exothermic charging of the fuel gas into the fuel gas storage material can also be transferred from the interior of the tank into the flow passage where it can be absorbed by the fuel gas flow being guided through the filter tube. Multiple filter tubes may be disposed within the tank interior that communicate with one another. Additionally, the system includes an external flow path that can recirculate fuel gas from the tank inlet to the tank outlet, as well as a fuel gas charging amplifier located along the external flow path.

When filling the fuel gas storage tank with fuel gas, a flow of fuel gas is introduced into the inlet of the tank. The fuel gas flow then travels along the flow passage of the one or more filter tubes. As the flow of fuel gas travels along the flow passage, some of the fuel gas diffuses out of the filter tube and into the interior of the tank where it comes into contact with, and is charged into, the fuel gas storage material. At the same time, heat from the exothermic charging (adsorption, chemical uptake, or both) of the fuel gas into the fuel gas storage material is transferred from the interior of the tank to inside the filter tube in the opposite direction from the diffusing fuel gas. In this way, heat that is generated from charging of the fuel gas storage material can be absorbed by the flow of fuel gas traveling through the filter tube and eventually removed from the fuel gas storage tank through the tank outlet. The ability to remove generated heat from the fuel gas storage tank during filling can improve the rate at which fuel gas is charged into the fuel gas storage material and ultimately speed up the time it takes to fill the tank to the desired level.

The fuel gas charging amplifier located along the external flow path can be operated to reject the heat acquired by the flow of fuel before it is recirculated back into the fuel gas storage tank. The fuel gas charging amplifier may include a heat exchanger, a compressor, or both, among other possibilities. As such, the fuel gas charging amplifier can be controlled to change the pressure and/or reduce the temperature of the fuel gas flowing along the external flow path—and thus the one or more filter tubes—to exert influence over the rate at which fuel gas is being charged into the fuel gas storage material. And to help the fuel gas charging amplifier operate in a way that achieves the desired metrics for filling the fuel gas storage tank, a controller may interface with and control the fuel gas charging amplifier based on one or more measured characteristics of the fuel gas flow being directed along the external flow path as well as one or more measured characteristics of the fuel gas storage tank.

### BRIEF DESCRIPTION OF THE DRAWINGS

FIG. 1 is a schematic view of an example of a fuel gas storage tank filling system;

FIG. 2 is an enlarged view of the fuel gas storage tank of FIG. 1, illustrating fuel gas diffusion through a filter tube in one direction and heat transfer through the filter tube in the opposite direction;

FIG. 3 is a flow chart illustrating an example of a control scheme for filling the fuel gas storage tank using the filling system;

FIG. 4 is a flow chart illustrating another example of a control scheme for filling the fuel gas storage tank using the filling system;

FIG. 5 is a qualitative plot of the amount of fuel gas adsorbed during a filling event with respect to time;

FIG. 6 is a perspective and partial cutaway view of an embodiment of the fuel gas storage tank that includes a plurality of filter tubes that fluidly communicate with one another along a path from the inlet to the outlet of the fuel gas storage tank; and

FIG. 7 is a perspective and partial cutaway view of another embodiment of the filter tube.

### DETAILED DESCRIPTION

The system and methods of filling a fuel gas storage tank described below can be used with any tank structure that stores fuel gas at a relatively low pressure in a solid state. The fuel gas storage tank includes fuel gas storage material that permits a fuel gas, such as natural gas or hydrogen gas, to be stored at an energy density comparable to that of compressed fuel gas, but at lower tank pressure. For example, the amount of adsorbed natural gas (ANG) that can be stored on an ANG storage material at 35 bars of tank pressure is approximately the same as the amount of compressed natural gas that can be stored in a tank of the same volume at 240 bars of tank pressure. The following system and methods are useful to lessen or minimize the time required to fill the fuel gas storage tank by monitoring certain tank filling conditions and employing a fuel gas charging amplifier to boost the rate of adsorption and or chemical uptake of the fuel gas by the fuel gas storage material in the tank.

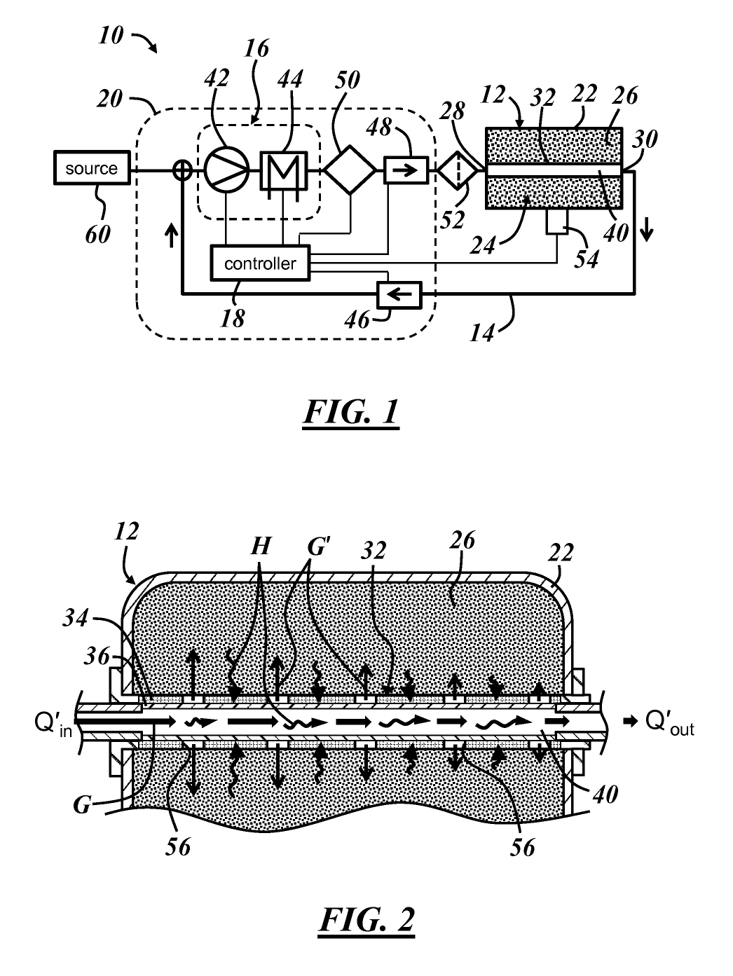

FIG. 1 is a schematic illustration of one example of a fuel gas storage tank filling. The illustrated system 10 includes a fuel gas storage tank 12, an external flow path 14, a fuel gas charging amplifier 16 located along the external flow path 14, and a controller 18 adapted to control operation of the fuel gas charging amplifier 16 and/or other system components. In this particular example, at least a portion of the external flow path 14, the fuel gas charging amplifier 16, and the controller 18 are included as part of a fuel gas filling station 20, while the storage tank 12 is part of a vehicle (not shown). It is also possible that one or more of the illustrated filling station components is included as part of the vehicle or some other intermediate device. During a filling event, a flow of fuel gas is circulated into the storage tank 12, out of the tank 12, along the external flow path 14, and back into the storage tank 12. The flow of fuel gas is circulated along this loop until a predetermined amount of fuel gas is stored in the tank 12.

The fuel gas storage tank 12 includes a shell 22 at least partly defining an interior 24 of the tank 12 and fuel gas storage material 26 located within the interior 24 of the tank 12. The storage tank 12 also includes an inlet 28 and an outlet 30. At least one of the inlet 28 or the outlet 30, and preferably both, fluidly communicates with a filter tube 32. The filter tube 32, as shown, is disposed within the interior 24 of the storage tank 12 and defines a flow passage 40 on its inside. Fuel gas can flow within and along this flow passage 40 without having to directly contact and navigate through the bulk of the fuel gas storage material 26. As fuel gas flows along the flow passage 40—which may constitute at least part of the path between the tank inlet 28 and the tank outlet 30—a portion of the fuel gas diffuses through the filter tube 32 and into the region of the tank interior 24 occupied by the fuel gas storage material 26. The fuel gas that does not diffuse through the filter tube 32 eventually exits the tank 12 through the tank outlet 30 and continues on through the exterior flow path 14. The exterior flow path 14 fluidly connects the tank outlet 30 to the tank inlet 28 as part of a flow path that recirculates gas from the tank outlet 30 to the tank inlet 28.

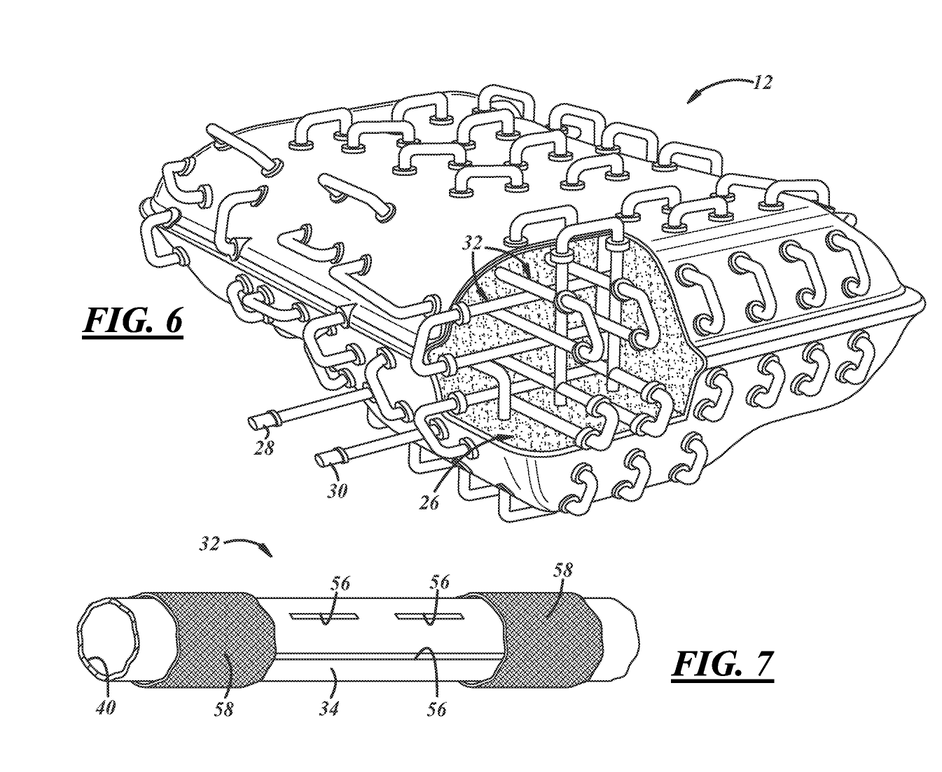

In the schematic representation of FIG. 1, a single filter tube 32 is illustrated that extends through the tank interior 24 from one portion of the shell 22 to another portion. The number of filter tubes 32 associated with the storage tank 12, however, is not limited to one. The storage tank 12 may include a multitude of such filter tubes 32 that fluidly communicate with one another along the path between the tank inlet 28 and the tank outlet 30. Fluid connections between multiple filter tubes 32 may be located within the interior 24 of the tank 12, at the shell 22, and/or outside the tank 12. Each filter tube 32 may be located entirely within the tank interior 24 or have at least a portion extending outside the tank 12. Additionally, the filter tube 32 (or tubes) is preferably arranged in a grid or other array to help distribute fuel gas within the tank interior 24 for more uniform charging to all parts of the fuel gas storage material 26. A tank that includes such an array of filter tubes 32 is shown in FIG. 6. A more detailed description of a conformable fuel gas storage tank, like the one shown in FIG. 6, that includes at least one filter tube for delivering fuel gas into the tank interior can be found in commonly-assigned PCT patent application No. PCT/US14/62588. The entire contents of PCT patent application No. PCT/US14/62588 are incorporated herein by reference.

The fuel gas storage tank 12 is preferably constructed to have one inlet 28 and one outlet 30, but that is not necessarily required. The inlet 28 and the outlet 30 may be located at different ports on the tank shell 22 or, in other embodiments, they may be co-located at a common port so that only a single mating connector is needed to establish an operable connection with the external flow path 14. For instance, in the common port embodiment, the inlet 28 and outlet 30 may be arranged so that fuel gas flows in one direction through a first central opening in the port and in the opposite direction through a second peripheral opening in the port that is isolated from the first opening. Skilled artisans will know and understand the various ways to design and configure the tank inlet 28 and tank outlet 30 as part of the tank shell 22 and, as such, a more detailed description of their various configurations is not necessary here.

The fuel gas storage material 26 is located within the interior 24 of the tank 12 and outside of the filter tube 32. The fuel gas storage material 26 can be any material that is capable of reversibly storing the fuel gas in a solid state. Natural gas and hydrogen gas are two notable types of fuel gas that may be stored in such a way. Natural gas is a combustible fuel whose largest gaseous constituent is methane (CH₄). The preferred type of natural gas that is employed in the filling system 10 is refined natural gas that includes 90 wt. % or greater, and preferably 95 wt. % or greater, methane. The other 5 wt. % or less may include varying amounts of natural impurities—such as other higher-molecular weight alkanes, carbon dioxide, and nitrogen—and/or added impurities. Hydrogen gas is also a well known combustible fuel having the chemical formula H₂. The fuel gas storage material 26 may, accordingly, be an ANG storage material if the fuel gas is natural gas or a hydrogen storage material if the fuel gas is hydrogen gas.

An ANG storage material (for storing adsorbed natural gas) is typically a porous adsorbent material. It may be incorporated into the fuel gas storage tank 12 in granulized form, powderized form, or any other suitable form. The average particle size of the ANG storage material pieces may even change over time as those pieces undergo fragmentation as a result of thermal, pressure, and loading cycles. Some specific examples of materials that can comprise some or all of the ANG storage material are activated carbon, metal-organic-frameworks, or porous polymer networks. Activated carbon is a carbonaceous substance, typically charcoal, that has been “activated” by known physical or chemical techniques to increase its porosity and surface area. A metal-organic-framework, as mentioned before, is a high surface area coordination polymer having an inorganic-organic framework, often a three-dimensional network, that includes metal ions (or clusters) bound by organic ligands. A porous polymer network is a covalently-bonded organic or organic-inorganic interpenetrating polymer network that, like MOFs, provides a porous and typically three-dimensional molecular structure.

Any of a wide variety of MOFs and PPNs may be used as the ANG storage material. Some notable MOF's and PPN's that may be used as the ANG storage material are disclosed in R. J. Kuppler et al., Potential applications of metal organic frameworks, Coordination Chemistry Reviews 253 (2009) pp. 3042-66, D. Yuan et al., Highly Stable Porous Polymer Networks with Exceptionally High Gas-Uptake Capacities, Adv. Mater. 2011, vol. 23 pp. 3723-25, W. Lu et al., Porous Polymer Networks: Synthesis, Porosity, and Applications in Gas Storage/Separation, Chem. Mater. 2010, 22, 5964-72, and H. Wu et al., Metal-Organic Frameworks with Exceptionally High Methane Uptake: Where and How Methane is Stored?, Chem. Eur. J. 2010, 16, 5205-14. Of course, a wide variety of MOFs and PPNs are commercially available and suitable for use as the gas storage material 14, and many others are constantly being researched, developed, and brought to market.

A hydrogen storage material (for storing hydrogen gas) is also typically a porous material. Materials that can function as a hydrogen storage material generally have the ability to reversibly store hydrogen gas as a hydride through chemical uptake. These types of materials include metal hydrides and complex metal hydrides. One specific example of a suitable metal hydride includes lithium hydride (LH). Complex metal hydrides may include various known alanates and amides. Some specific complex metal hydrides include sodium alanate (NaAlH₄), lithium alanate (LiAlH₄), magnesium nickel hydride (Mg₂NiH₄), and lithium amide (LiNH₂). There are, of course, many other hydrogen storage materials that are commercially available besides metal hydrides and complex metal hydrides. For example, MOFs and PPNs as referenced in the above literature may be used for hydrogen storage, although the storage mechanism associated with such materials is by way of adsorption rather than chemical uptake.

FIG. 2 is an enlarged view of the fuel gas storage tank 12 of FIG. 1 that depicts the interaction between the fuel gas storage material 26 and the fuel gas in the filter tube 32 during filling. The filter tube 32 is constructed to separate the bulk of the fuel gas storage material 26 from the flow passage 40 and to permit a portion of a flow of fuel gas G traveling along and through the flow passage 40 to diffuse out of the flow passage 40 and into the tank interior 24. In this way, fuel gas can be routed through the tank interior 24 and delivered more uniformly to the fuel gas storage material 26 by way of diffusion as opposed to being pumped directly into the tank interior 24 and dispersed interstitially through the bulk of the storage material 26. Additionally, heat generated by the exothermic charging of the fuel gas storage material 26 can be transferred from the tank interior 24 into the filter tube 32 where it can be absorbed and carried away by the flow of fuel gas G flowing through the flow passage 40. The construction of the filter tube 32 can take on many variations, some of which are described in greater detail below.

In one particular embodiment, as shown in FIG. 2, each filter tube 32 includes a structural wall 34 and a membrane 36. The structural wall 34 supports the membrane 36, which in some cases does not have sufficient strength and integrity to maintain its own shape in the interior 24 of the tank 12. In this example, the membrane 36 is located within and is supported by an inner circumferential surface of the structural wall 34, but it could be also located outside the structural wall 34 or between the structural wall 34 and another component (not shown) of the filter tube 32. The structural wall 34 and the membrane 36 together allow fuel gas to diffuse from the flow passage 40 defined inside the filter tube 32 to outside the filter tube 32 where it can be charged into the fuel gas storage material 26 by adsorption, chemical uptake, etc. The filter tube 32 may include additional layers not explicitly shown here.

The structural wall 34 includes at least one opening 56 that communicates with the flow passage 40 so that fuel gas can pass through it. The at least one opening 56 can be an elongated slot or slots, a series of spaced apart round holes, or some other type of fuel gas navigable opening. As such, the structural wall 34 may be a tubular metal extrusion or casting having at least one elongated slot and/or a series of holes, or any other type of porous wall configuration, and it may be formed from stainless steel, an aluminum alloy, a plastic, or some other material of sufficient strength, durability, and thermal conductivity. While the exact size and construction of the structural wall 34 may vary based on the size and pressure constraints of the fuel gas storage tank 12, the type and quantity of the fuel gas storage material 26 contained within the tank 12, and a variety of other factors, the structural wall 34 is typically designed to have a diameter that ranges from about 5 mm to about 20 mm and a wall thickness that ranges from about 1 mm to about 10 mm. The openings 56, moreover, are typically sized to exclude the passage of granules, particles, or other pieces of the fuel storage material 26 that are sized above a certain particles size that may lie anywhere between about 10 μm to about 2 mm.

The membrane 36 is preferably a micro- or ultra-filtration material or film that is fuel gas permeable. The membrane 36 has a thickness that typically ranges from about 20 μm to about 2 mm, and includes a network of interconnected pores through its thickness to render the membrane 36 porous. The pores are sized to allow diffusion of the fuel gas from inside the flow passage 40 of the filter tube 32 to the fuel gas storage material 26 outside the filter tube 32. The pores may also be sized to prevent the passage of granules, particles, or other pieces of the fuel storage material 26 above a certain size—and which may be small enough to pass through the structural wall 34—from passing through the thickness of the membrane 36 and possibly entering the flow passage 40. An average pore size of about 10 μm to about 50 μm is typically sufficient in such circumstances, although greater and smaller pore sizes may be employed. While a number of micro- or ultra-filtration membranes exist and are known in the art to be fuel gas permeable, the membrane 36 included in the filter tube 32 is preferably a hydrophilic zeolite such as ZSM-5, which can help reduce water contamination of the fuel storage material 26, or an organic polymer-based membrane. The membrane 36 can be appended to the structural wall 34 by any known technique.

The structural wall 34 and the membrane 36 cooperate to perform a number of functions in this particular embodiment of the filter tube 32. First, the structural wall 34 and the membrane 36 allow fuel gas to diffuse out of the filter tube 32 and, as will be discussed below, allow heat to transfer into the filter tube 32. This cross-flow of fuel gas diffusion and heat transfer through the filter tube 32 helps improve the rate at which the fuel gas storage material can be charged with fuel gas. Second, the arrangement of the structural wall 34 and the membrane 36 relies on the structural wall 34 to bear most or all of the load from the surrounding fuel gas storage material 26 while additionally providing a barrier—i.e., the membrane 36—to prevent fractured or crumbled bits of the fuel storage material 26 above a certain size from passing through the filter tube 32 and into the flow passage 40. Keeping unacceptably-sized fuel gas storage material 26 from entering the flow passage 40 and being carried away by the flow of fuel gas G traveling along the flow passage 40 helps avoid loss of overall fuel gas storage capacity for the tank 12 as well as contamination or harm to other system components. Third, the membrane 36 can help control the quantity and kind of impurities that are introduced to the fuel gas storage material 26. Water, for example, which can occupy gas storage sites within the fuel gas storage material 26, can be selectively trapped by the membrane 36 if the membrane 36 contains or is formed from hydrophilic material like a zeolite.

The filter tube 32 can have other constructions besides the one just described yet still function in a similar manner. For example, as shown in FIG. 7, the structural wall 34 of the filter tube 32 may be include one or more elongated slots and/or other (e.g., round) openings 56, and may further include a mesh structure 58 as a substitute for the membrane 36. The mesh structure 58 can include interrelated wires or woven metal and can be constructed from aluminum alloy or stainless steel, among other possibilities. As with the membrane 36, the mesh structure 58 could be carried on the outside of the structural wall 34, as shown here, or it could be located within and be supported by an inner circumferential surface of the structural wall 34 (as shown in FIG. 2 with the membrane 36) or be located between the structural wall 34 and another component (not shown) of the filter tube 32. The mesh structure 58 may have a thickness about 20 μm to about 2 mm and includes a network of interconnected gas-navigable openings or pores that render the mesh structure 58 porous to the flow of fuel gas. The interconnected openings or pores, as before, may be sized to prevent the passage of granules, particles, or other pieces of the fuel gas storage material 26 above a certain size from entering the flow passage 40. In some instances, for example, the mesh structure will mechanically exclude pieces of the fuel gas storage material 26 above 50 μm from passing through it and possibly entering the flow passage 40 through the openings defined in the structural wall 34. The exclusion of larger or smaller sized pieces can also be implemented if needed.

Still further, in another embodiment, the filter tube 32 may include the structural wall 34 without the additional membrane 36 or the mesh structure 58. In this embodiment, the openings defined by the structural wall 34 may themselves be sized to exclude all pieces of the fuel gas storage material 26 above a certain size from passing through it and entering the flow passage 40 of the filter tube 32. The structural wall 34, for example, can be provided with openings that are small enough to exclude the passage of fuel storage material pieces (granules, powder, etc.) from outside the filter tube 32 to inside the filter tube 32 while taking into account the fact that the average particle size and particle size distribution of the fuel storage material 26 may change over time as temperature, pressure, and load cycling during repeated filling and discharge cycles can lead to fragmentation of the fuel gas storage material 26. The structural wall 34 of this embodiment can have any of the above-mentioned constructions—e.g., a tubular metal extrusion or casting having at least one elongated slot and/or perforations, or any other type of porous wall configuration—and the size of its openings can vary depending on the composition and physical characteristics of the fuel gas storage material 26. In a preferred implementation, however, the openings defined in the structural wall 34 are sized to exclude pieces of the fuel gas storage material 26 above 10 μm, or in some instances above 50 μm, from passing through it and possibly entering the flow passage 40. The membrane 36 or the mesh structure 58 may also be used as the filter tube 32 in the absence of the structural wall 34, although they may have to be thicker than before if used in that scenario.

During a filling event, fuel gas is delivered to the filling system 10 by a fuel gas source 60. The fuel gas supplied by the fuel gas source 60 plus any fuel gas returning from the external flow path 14 provides the flow of fuel gas G that is fed to the storage tank 12. The fuel gas source 60 is preferably a tapped residential or commercial gas distribution network or a large underground storage tank that supplies fuel gas at a pressure ranging from about 1 bar to about 50 bar. It is also possible, as another example, for the fuel gas source 60 to be a compressed fuel gas tank that stores fuel gas at a pressure greater than 200 bar. The compressed fuel gas tank may be outfitted with a Joule-Thompson valve and an expansion tank that, together, throttle the compressed fuel gas to a lower pressure of about 1 bar to about 50 bar for delivery to the filling system 10. Still further, the fuel gas source 60 could be a cryogenic tank that holds liquefied fuel gas at a pressure of up to about 2 bar. A heat exchanger may be used in conjunction with the cryogenic tank to evaporate the liquified fuel gas for delivery to the filling system 10.

The flow of fuel gas G enters the storage tank 12 through the tank inlet 28 at an instantaneous mass flow rate Q′ᵢₙ, flows along the flow passage 40 of the filter tube 32, and exits the tank 12 through the tank outlet 30 at an instantaneous mass flow rate Q′ₒᵤₜ. As the fuel gas G flows along the flow passage 40 of the filter tube 32, some of the gas G′ diffuses through the filter tube 32 for charging (e.g., adsorption, chemical uptake) into the fuel storage material 26. The direction of fuel gas diffusion through the filter tube 32 is generally transverse to the direction of gas flow inside the filter tube 32 along the flow passage 40. In this arrangement, where the fuel gas G flowing into the storage tank 12 does not impinge or flow directly across the fuel storage material 26 and is only dispensed through the filter tube 32, the pressure required to direct the fuel gas flow G through the tank 12 is relatively low, and the diffused fuel gas G′ is charged more uniformly along the length of the filter tube 32 than if the gas flow G had been simply pumped into direct contact with the fuel gas storage material 26.

The process of charging fuel gas into the fuel gas storage material 26 is exothermic, meaning that thermal energy or heat is released from the fuel gas storage material 26 when fuel gas molecules (as well as other molecules) are acquired by the storage material 26 for solid state storage. As shown in FIG. 2, heat H is transferred through the filter tube 32 because a temperature gradient typically exists between the fuel gas storage material 26—which is exothermically adsorbing fuel gas—and the flow of fuel gas G in the flow passage 40. The heat H is transferred through the filter tube 32 in a direction opposite that of the diffusing fuel gas G′, resulting in a cross-flow of fuel gas G′ and heat H through the filter tube 32. The heat H that is transferred into the flow passage 40 from the surrounding fuel gas storage material 26 is carried out of the storage tank 12 by the fuel gas flow G traveling along the flow passage 40 inside the filter tube 32.

Thus, during tank filling, diffused fuel gas G′ and heat H are exchanged through the filter tube 32 and between the flow of fuel gas G in the flow passage 40 and the fuel gas storage material 26 located outside of the filter tube 32. It is not uncommon for the rate of fuel gas diffusion and heat transfer to vary along the length of the filter tube 32 as is shown schematically in FIG. 2. Upon exiting the storage tank 12 through the tank outlet 30, the flow of fuel gas G contains less fuel gas and more heat H than it did when entering the tank 12.

In the example of FIG. 2, over any given period of time during the filling event, the cumulative amount of fuel gas charged into the fuel gas storage material 26 is the difference between the cumulative amount of fuel gas entering the tank Qᵢₙ and the cumulative amount of fuel gas exiting the tank Qₒᵤₜ during that time, or:

Qₙₑₜ=Qᵢₙ−Qₒᵤₜ

where Qₙₑₜ is the amount of fuel gas charged during filling over a given time period, expressed in units of mass or moles. The cumulative values of Qᵢₙ and Qₒᵤₜ can be obtained by integrating the instantaneous fuel gas mass flow rates Q′ᵢₙ and Q′ₒᵤₜ or by referencing empirical data or other indicative information. The controller 18 can perform this function as will be described in more detail below.

The exothermic nature of the fuel gas charging process can limit the rate of fuel gas adsorption and the amount of fuel gas contained within the storage tank 12. This is true because the heat generated by the charging process (e.g., adsorption or chemical uptake) can raise the temperature of the fuel gas storage material 26 which, in turn, works to release some of the fuel gas. In other words, as the fuel gas storage material 26 increases in temperature during charging, the rate at which fuel gas is accumulated is reduced (i.e., the difference between the competing rates of fuel gas charging and release converge as the temperature of the fuel gas storage material 26 increases) unless the heat produced by the charging process can be rejected. Directing the flow of the fuel gas G through the storage tank 12 within the filter tube(s) 32, as illustrated in FIGS. 1 and 2, helps in this regard by carrying generated heat H away from the fuel gas storage material 26. The removal of generated heat H and its rejection outside of the storage tank 12 helps to consistently maintain the higher fuel gas charging rate of a cooler fuel gas storage material 26 during the filling event.

Referring again to FIG. 1, the re-circulation of the fuel gas flow G through the storage tank 12 by way of the external flow path 14 allows for an excess of fuel gas to flow through the tank 12 without waste. It also provides a flow mechanism for removing generated heat H from the storage tank 12 and conveying that heat H to some other location for rejection. The re-circulation of the fuel gas flow G and its heat rejection capability allows, for example, about 5-6 kg/min of diffused fuel gas G′ to be introduced into the interior 22 of the tank for charging into the fuel gas storage material 26 when the fuel gas flow G entering the tank 12 (Qᵢₙ) is set at 100 kg/min. Under such circumstances, where the percentage of G′ to Qᵢₙ is upwards of 6%, a typical fuel gas storage tank with a 30 kg fuel gas capacity can be filled in six minutes or less. The filling time can be further reduced, if desired, by increasing Qᵢₙ and/or the gain of the fuel gas charging amplifier 16. Other arrangements of the tank filling system 10 are possible, besides what is expressly shown in FIG. 1, while still realizing the functionality of the above-described filter tube 32. For instance, the flow of fuel gas G could be directed through the storage tank 12 as shown in FIG. 2 with some of the fuel gas that exits the tank 12 being diverted elsewhere in the system 10 such as to an exhaust destination. Any diverted fuel gas that leaves the filling system 10 can simply be replenished by the fuel gas source 60.

In the filling system 10 illustrated in FIG. 1, the fuel gas charging amplifier 16 and the controller 18 cooperate to control the rate of charging of fuel gas into the fuel gas storage material 26. The fuel gas charging amplifier 16 in this example includes a compressor 42 and a heat exchanger 44. The compressor 42 can change the pressure of the flow of fuel gas G along the external flow path 14, and the heat exchanger 44 can remove heat from the flow of fuel gas G when needed. In addition to its function as a fuel charging amplifier component, the compressor 42 may also function as a pump to provide the pressure differential necessary to circulate the flow of fuel gas G through the system 10 if there is not enough pressure supplied by the fuel gas source 60. The compressor 42 may be particularly useful, for instance, if the fuel gas source 60 is a residential or a commercial gas distribution network, which typically supplies fuel gas at a pressure down to about 1 bar.

The compressor 42 and the heat exchanger 44 can be operated by the controller 18 to control the flowrate (Qᵢₙ and Q′ₒᵤₜ) and temperature of the flow of fuel gas G being passed through the storage tank 12 by way of the filter tube(s) 32. The heat exchanger 44 can decrease the temperature of the fuel gas flow G to within an operating range of, for example, about −50° C. to about 0° C. by extracting heat from the gas flow G with a coolant that simultaneously traverses the heat exchanger 44 in heat exchange relation with the fuel gas flow G. Decreasing the temperature of the flow of fuel gas G passing along the flow passage 40 of the filter tube 32 has the effect of increasing the temperature gradient between the fuel gas storage material 26 and the gas flow G, which thermodynamically favors the transfer of H through the filter tube 32 and into the fuel gas flow G as the heat is generated by fuel gas charging into the fuel gas storage material 26. As for the compressor 42, it can increase the pressure of the fuel gas flow G within an operating range of, for example, about 35 bars to about 50 bars if the fuel gas source 60 does not otherwise contribute that type of pressure. An increase in pressure of the fuel gas flow G speeds up its flowrate through the storage tank 12, the flow passage 40 of the filter tube 32, and the system 10. A greater flowrate of the fuel gas flow G, in turn, helps maintain the maximum desired temperature gradient between the fuel gas storage material 26 and the gas flow G by removing the transferred heat H from the interior 24 of the storage tank 12 more quickly. Though under the control of the controller 18 in the illustrated example, the compressor 42 and/or the heat exchanger 44 can operate in the absence of the controller 18, if desired; that is, they can simply be powered “on” during the filling event at a particular operational state (e.g., maximum pressure and maximum heat removal) and powered “off” afterwards without independent instruction from the controller 18.

The system 10 includes additional components, some of which provide information to the controller 18 with respect to the fuel gas flow G being passed through the system 10. The system 10 includes a first measurement device 46 located upstream from the fuel gas charging amplifier 16, a second measurement device 48 located downstream from the fuel gas charging amplifier 16, and a third measurement device 54 located at the storage tank 12. Each of the first and second measurement devices 46, 48 measures one or more characteristics of the fuel gas flow G being directed along the external flow path 14. The third measurement device 54 measures one or more characteristics of the storage tank 12. The controller 18 receives measurements from the measurement devices 46, 48, 54 and controls operation of the fuel gas charging amplifier 16 based at least in part on the received measurements. In the schematic representation of FIG. 1, each illustrated measurement device 46, 48, 54 is intended to depict one or more different types of measurement devices, whether provided together as a unit or provided as separate devices.

Each of the first and second measurement devices 46, 48 preferably includes a flow meter or is a flow meter that measures the volumetric flow rate and/or the mass flow rate of the fuel gas flow G being directed along the external flow path 14 at the location of the respective device. The first and second flow devices 46, 48 may even be a single differential flow meter that measures the fuel gas flow G entering and exiting the storage tank 12 at a single location. Flow meters are useful for determining the amount of fuel gas being charged into the fuel gas storage material 26 by periodically or continuously measuring Qᵢₙ and Q′ₒᵤₜ and providing those measurements to the controller 18. The controller 18 receives these measurements and determines the amount of fuel gas charged into the fuel gas storage material 26 during filling over a given period of time as described above (Qₙₑₜ=Qᵢₙ−Qₒᵤₜ).

Each of the first and second measurement devices 46, 48 may be adapted, as individual or integrated components, to measure gas temperature, gas pressure, volumetric flow rate, mass flow rate, moisture content, or any combination of these or other gas characteristics at different locations of the fuel gas flow G within the filling system 10. For instance, in the illustrated example, the system 10 includes a drier 50 located along the external flow path 14 that is controlled by the controller 18. The controller 18 may receive moisture content measurements from one or both of the first and second measurement devices 46, 48 and, based on that data, can selectively operate the drier 50 to remove moisture from the fuel gas flow G. The controller 18 can receive information from any number of system devices, process the information, and control other system devices based on the processed information. The filling system 10 can include other components as well, such as the illustrated pre-filter 52 for additional impurity containment, valves, connectors, and additional controllers, to name but a few. The fuel gas charging amplifier 16 may also include additional components operable to increase the rate of natural gas adsorption by the ANG storage material 26.

The third measurement device 54 may be one or more sensors that measure the temperature and/or pressure of the interior 24 of the tank 12. Temperature and pressure measurements can be used to calculate or otherwise determine the amount of fuel gas consumed during vehicle operation and, consequently, the remaining amount of fuel gas stored in the fuel gas storage material 26 at a given time. In particular, the third measurement device 54 can gauge how much fuel gas is still present, Qₛₜₐᵣₜ, in the tank 12 just before filling is commenced. It can also be used to corroborate the fuel gas charging valuations (e.g., Qᵢₙ, Qₒᵤₜ, Qₙₑₜ) obtained from measurements taken by the first and second measurement devices 46, 48 during the filling event. A separate controller (not shown) on-board the vehicle may monitor the third measurement device 54 apart from the first and second measurement devices 46, 48, if desired, and may track the amount of fuel gas stored and/or consumed by the vehicle and communicate this information to the filling system controller 18 at the beginning of a filling event so that an accurate gauge of Qₛₜₐᵣₜ can be accounted for during filling.

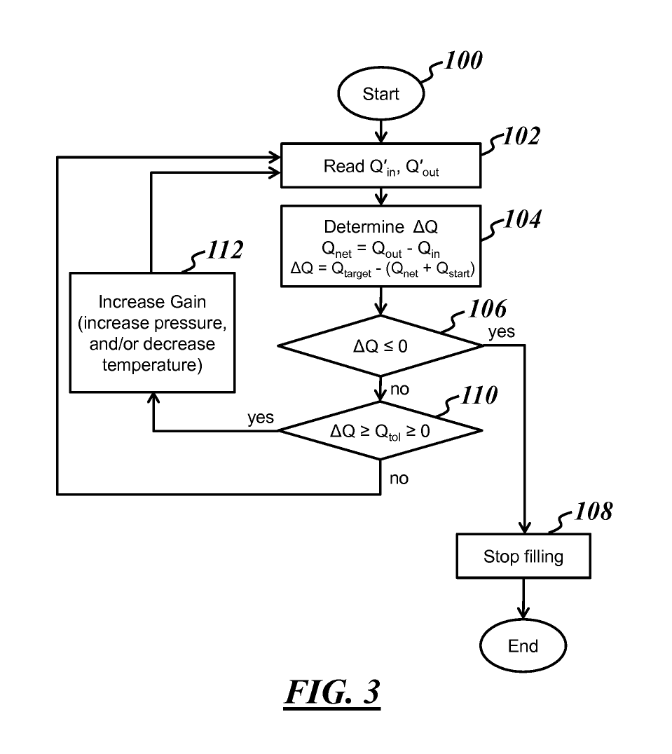

FIG. 3 is a flow chart illustrating one example of the manner in which the system controller 18 can operate to control operation of the filling system 10 during the tank filling event. At step 100, the tank filling event begins by, for example, connecting the storage tank 12 to the fuel gas filling station 20 and establishing from the third measurement device 54 how much fuel gas (Qₛₜₐᵣₜ) is still present in the storage tank 12. Then, at step 102, as the filling event proceeds, the controller 18 receives information from the first and second measurement devices 46, 48 within the system 10 indicating the instantaneous flow rates of the fuel gas flow G into the storage tank 12 (Q′ᵢₙ) and out of the tank 12 (Q′ₒᵤₜ). From the received information, the controller 18 can determine how much fuel gas has been added to the storage tank 12 over a given timer period during the filling event. This is illustrated at step 104, where Qₙₑₜ is determined from the difference between Qₒᵤₜ and Qᵢₙ. The controller 18 can perform an integration step or reference an empirically-generated look-up table to determine Qₒᵤₜ and Qᵢₙ from the instantaneous flow rate measurements (Q′ᵢₙ and Q′ₒᵤₜ). Additionally at step 104, the controller 18 compares the amount of fuel gas actually stored in the storage tank 12 at a given time, Qₛₜₐᵣₜ+Qₙₑₜ, against a desired amount of stored fuel gas, Q_{target}, which may or may not be equal to the full capacity of the storage tank 12. The difference between Q_{target} and the amount of fuel gas stored in the tank 12 (Qₛₜₐᵣₜ+Qₙₑₜ) is represented in step 104 as ΔQ.

If ΔQ [Q_{target}−(Qₛₜₐᵣₜ+Qₙₑₜ)] is greater than zero, then the storage tank 12 has not been filled to the desired level. If ΔQ is less than or equal to zero, then the storage tank 12 is filled to the desired level. The controller 18 makes this determination at step 106 in the illustrated example. If the storage tank 12 is filled to the desired level (ΔQ≦0), then the controller 18 instructs the filling system 10 to stop filling the tank 12 (e.g., by closing a system valve, powering down a system compressor, opening a by-pass valve, etc.) as indicated at step 108. When ΔQ is greater than zero, which is the case for essentially the entire duration of the filling event, the controller 18 decides how to operate the fuel gas charging amplifier 16 at step 110. If the tank 12 is nearly full, within a tolerance band Qₜₒₗ such that ΔQ<Qₜₒₗ, the controller 18 does not change the operating parameters of the fuel gas charging amplifier 16 and returns to step 102 and continuously repeats steps 102, 104, 106 and 110 until ΔQ≦0 at step 106. When ΔQ is not within the tolerance band Qₜₒₗ, the controller 18 operates to increase the gain of the fuel gas charging amplifier 16 at step 112 before returning to step 102 so that the tank 12 fills more quickly. As shown in FIG. 3, this may include increasing the pressure of the flow of fuel gas G and/or decreasing the temperature of the gas flow G entering the storage tank 12 by operating the system compressor 42, the heat exchanger 44, or both as needed.

Step 112 may include a simple on-off operation of the fuel gas charging amplifier components. For instance, the compressor 42 and/or heat exchanger 44 may operate at respective maximum temperature-reducing capacities until the storage tank 12 is filled to the desired level. In other embodiments, the components 42, 44 of the fuel gas charging amplifier 16 may each operate within a range between zero and a maximum gain capacity.

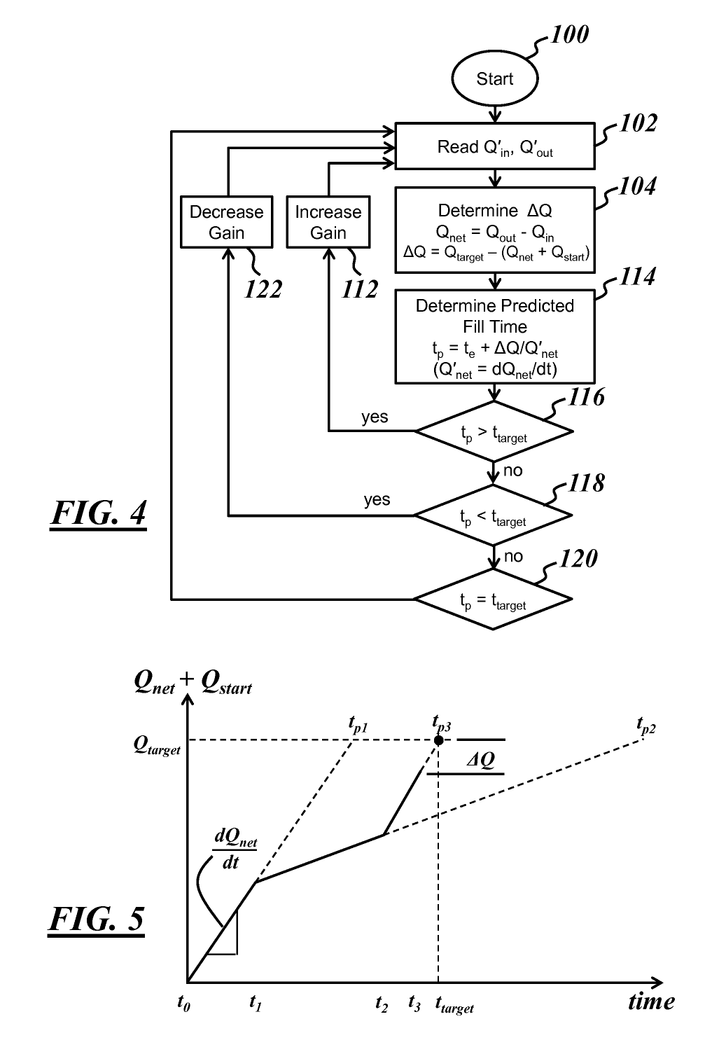

The filling system 10 illustrated in FIG. 1 can operate to achieve a target filling time, even if the system 10 is capable of filling the storage tank 12 in a shorter time. For instance, the remaining fill amount ΔQ and rate of change of Qₙₑₜ may be monitored by the controller 18 and used to extrapolate a predicted fill time tₚ as shown in the control scheme of FIG. 4 at step 114. The predicted fill time tₚ can be calculated by adding the time elapsed so far in the filling event, represented by the letter tₑ, to the quotient of the amount of fuel gas that still needs to be added (ΔQ) to the fuel gas storage material 26 and the fuel gas charging rate, which is given by the equation:

$${t}_{P} = {t}_{e} + \frac{Δ Q}{{Q}_{net}^{′}}$$

where

ΔQ equals [Q_{target}−(Qₛₜₐᵣₜ+Qₙₑₜ)] and Qₙₑₜ equals dQₙₑₜ/dt.

If the predicted fill time tₚ is greater than the target fill time (tₚ>t_{target}) at step 116, the controller 18 operates to increase the gain of the fuel gas charging amplifier 16 at step 112. If the predicted fill time tₚ is less than the target fill time (tₚ<t_{target}) at step 118, the controller 18 operates to decrease the gain of the fuel gas charging amplifier 16 at step 122. If the predicted fill time tₚ is equal to the target fill time (tₚ=t_{target}) at step 120, the controller 18 continues to operate the fuel gas charging amplifier 16 in its current operational state. The respective increases and decreases in the gain of the fuel gas charging amplifier 16 may include on-off (increase-decrease) operation of the amplifier components and/or changes in their operating parameters, such as increased or decreased turbine speed in the compressor 42 or increased or decreased flow rate of a heat exchange coolant in the heat exchanger 44 for respective increases or decreases in gain.

FIG. 5 graphically depicts some of the variables referenced in the control schemes shown in FIGS. 3-4 in a qualitative plot of (Qₛₜₐᵣₜ+Qₙₑₜ) with respect to time. Q_{target} is shown along the vertical (Qₛₜₐᵣₜ+Qₙₑₜ) axis and is the predetermined fill value that takes into account the known capacity of the storage tank 12 at a given set of conditions (e.g., tank volume, fuel gas storage material content, temperature, etc.). When the storage tank 12 is first put into service or when it is completely discharged (i.e., Qₛₜₐᵣₜ=0) and degassed of contaminants such as water and carbon dioxide, Q_{target} may be equal to the full capacity of the tank 12. During the life of the vehicle, however, Q_{target} may occasionally be less than the full capacity of the tank 12 by some amount to account for contaminants that may accumulate in the fuel gas storage material 26 over time. Q_{target} may also be less than the full capacity of the storage tank 12 in instances where it is desired to only partially fill the tank 12.

FIG. 5 also illustrates ΔQ at one point along the plot, representing how much more fuel gas must be added to the tank 12 to reach Q_{target}. FIG. 5 also shows the case where there is a target filling time, t_{target}. In this example, the fuel gas charging rate between t₀ and t₁, represented by the slope dQₙₑₜ/dt, results in a predicted fill time, tₚ₁, that is less than the target filling time t_{target}. According to the control scheme represented in FIG. 5, the gain of the fuel gas charging amplifier 16 would be decreased to effectively slow the fuel gas charging rate of the fuel gas storage material 26. The fuel gas charging rate between t₁ and t₂ results in a predicted fill time, tₚ₂, which is greater than the target filling time t_{target}, and the gain of the fuel gas charging amplifier 16 is increased to effectively increase the fuel gas charging rate of the fuel gas storage material 26. The fuel gas charging rate between t₂ and t₃ results in a predicted fill time, t₀, that is about the same as the target filling time t_{target}, and the controller 18 operates to maintain the gain of the fuel gas charging amplifier 16 at the same level. FIG. 5 is a simplified example, as the actual curve may be non-linear and include continuous adjustments of the amplifier gain by the controller 18 to achieve the target fill time, t_{target}. Additionally, the control scheme just described does not always have to be employed. There may be times when it is desired to fill the storage tank 12 in the shortest possible time span, during which time the gain of the fuel gas charging amplifier 16 is maximized, and there may be times when it is desired to fill the storage tank 12 slowly, during which time the fuel gas charging amplifier 16 is minimized or not relied on.

The above description of preferred exemplary embodiments and related examples are merely descriptive in nature; they are not intended to limit the scope of the claims that follow. Each of the terms used in the appended claims should be given its ordinary and customary meaning unless specifically and unambiguously stated otherwise in the specification.

1. A method of filling a fuel gas storage tank, the method comprising:
providing a fuel gas storage tank that houses a fuel gas storage material within an interior of the tank, the tank having an inlet, an outlet, and at least one filter tube disposed within the interior of the fuel gas storage tank, the filter tube defining a flow passage and being permeable to fuel gas such that fuel gas can diffuse from the flow passage inside the filter tube into the tank interior outside of the filter tube;
passing a flow of fuel gas from the inlet to the outlet of the storage tank and along the flow passage of a filter tube, wherein some of the fuel gas passing along the flow passage diffuses out of the filter tube and into the interior of the tank for charging into the fuel gas storage material;
removing the flow of fuel gas from the outlet of the storage tank and directing the flow of fuel gas along an external flow path; and
operating a fuel gas charging amplifier located in the external flow path to control the rate at which fuel gas is charged into the fuel gas storage material.

2. The method as set forth in claim 1, wherein heat is transferred through the filter tube from the fuel gas storage material to the flow of fuel gas traveling along the flow passage of the filter tube.

3. The method as set forth in claim 1, further comprising:
recirculating fuel gas removed from the outlet of the storage tank back to the inlet of the storage tank and through the flow passage of the filter tube after being acted upon by the fuel gas charging amplifier.

4. The method as set forth in claim 1, wherein the fuel gas charging amplifier comprises a heat exchanger, and wherein the step of operating the fuel gas charging amplifier comprises removing heat from the flow of fuel gas being directed along the external flow path.

5. The method as set forth in claim 1, wherein the fuel gas storage tank comprises a plurality of filter tubes that fluidly communicate with one another along a path between the inlet and the outlet of the tank, each of the plurality of filter tubes defining a flow passage on its inside and being fuel gas permeable,

6. The method as set forth in claim 1, wherein the fuel gas is natural gas and the fuel gas storage material is an adsorbed natural gas storage material.

7. The method as set forth in claim 6, wherein the natural gas storage material is a metal-organic-framework.

8. The method as set forth in claim 1, wherein the fuel gas is hydrogen gas and the fuel gas storage material is a hydrogen storage material.

9. The method as set forth in claim 8, wherein the hydrogen storage material is a metal hydride or a complex metal hydride.

10. A method of filling a natural gas storage tank, the method comprising:
(a) providing an fuel gas storage tank that includes a fuel gas storage material within an interior of the tank;
(b) introducing a flow of fuel gas into the storage tank along a flow passage defined by an inside of at least one filter tube that is disposed in the interior of the storage tank, the filter tube permitting fuel gas to diffuse from inside the filter tube to outside the filter tube and further permitting the transfer of heat from outside the filter tube to inside the filter tube;
(c) removing the flow of fuel gas from the storage tank and passing the flow of fuel gas along a flow path exterior to the storage tank;
(d) operating a fuel gas charging amplifier to remove heat from the flow of fuel gas passing along the flow path exterior to the storage tank; and
(e) introducing the flow of fuel gas back into the storage tank along the flow passage of the at least one filter tube.

11. The method as set forth in claim 10, further comprising:
(f) repeating steps (a) through (e) until a predetermined amount of fuel gas is stored in the fuel gas storage tank.

12. The method set forth in claim 10, wherein step (d) comprises operating a heat exchanger to remove heat from the flow of fuel gas being passed along the flow path exterior to the fuel gas storage tank.

13. The method set forth in claim 10, wherein the fuel gas is natural gas or hydrogen gas and the fuel gas storage material is an adsorbed natural gas storage material or a hydrogen storage material, respectively.

14. The method set forth in claim 10, wherein the step of removing the flow of fuel gas from the storage tank also removes heat from inside the storage tank that has been generated as a result of exothermic charging of the fuel gas into the fuel gas storage material.

15. A fuel gas storage tank filling system, the system comprising:
a fuel gas storage tank having a tank shell defining an interior, a tank inlet, a tank outlet, a filter tube disposed in the interior of the tank and in fluid communication with at least one of the tank inlet and the tank outlet, and a fuel gas storage material located within the interior of the tank and outside of the filter tube, the filter tube being constructed to permit fuel gas to diffuse from inside the filter tube to outside the filter tube and to further permit the transfer of heat from outside the filter tube to inside the filter tube;
an external flow path that fluidly communicates with the tank outlet and the tank inlet such that fuel gas removed from the tank outlet can be recirculated back to the tank inlet; and
an fuel gas charging amplifier located along the external flow path and adapted to control a rate of charging of fuel gas into the fuel gas storage material.
